(19) United States
(12) Patent Application Publication
(10) Pub. No.: US 2014/0023900 A1
(43) Pub. Date: Jan. 23, 2014

(54) SECONDARY BATTERY

(71) Applicant: Sony Corporation, Tokyo (JP)

(72) Inventors: Karin Tsuda, Fukushima (JP); Shinsaku Ugawa, Fukushima (JP); Akira Ichihashi, Fukushima (JP); Kazuo Honda, Fukushima (JP)

(73) Assignee: Sony Corporation, Tokyo (JP)

(21) Appl. No.: 14/034,123

(22) Filed: Sep. 23, 2013

Related U.S. Application Data
(63) Continuation of application No. 11/690,544, filed on Mar. 23, 2007, now abandoned.

(30) Foreign Application Priority Data
Mar. 27, 2006 (JP) 2006-085857

(51) Int. Cl. H01M 10/0587

(52) U.S. Cl. CPC H01M 10/0587
USPC 429/94

(57) ABSTRACT

A secondary battery is provided. The secondary battery includes a positive electrode having a positive electrode active material layer provided on a positive electrode current collector, a negative electrode having a negative electrode active material layer provided on a negative electrode current collector, and an electrolyte, in which the positive electrode and the negative electrode are stacked and rolled up while placing a separator in between. A sum (A+B) of a total thickness “A” of the positive electrode current collector and the positive electrode active material layer, and a total thickness “B” of the negative electrode current collector and the negative electrode active material layer ranges from 161 μm to 220 μm. A ratio (A/B) of the total thickness “A” to the total thickness “B” ranges from 0.65 to 1.9.

### CROSS REFERENCES TO RELATED APPLICATIONS

The present application is a Continuation of U.S. application Ser. No. 11/690,544, filed on Mar. 23, 2007, which claims priority to Japanese Patent Application JP2006-085857 filed in the Japanese Patent Office on Mar. 27, 2006, the entire contents of which is being incorporated herein by reference.

### BACKGROUND

The present disclosure relates to a secondary battery, and in particular to a lithium ion secondary battery operated at high charging voltages and excellent in cycle characteristics.

With a distinct progress in recent mobile electronics technology, electronic instruments such as mobile phones, notebook-type personal computers and so forth have been recognized as infrastructure technologies supporting the advanced information-oriented society. Extensive research and development regarding further functionalization of these instruments are in progress, and power consumption of these electronic instruments consequently keeps on increasing in proportion. On the contrary, there is a need of long-term operation of these electronic instruments, so that higher energy density has inevitably been required for secondary batteries used as operation power sources of these instruments.

In view of occupied volume and weight of the batteries incorporated in the electronic instruments, larger energy density of battery is more preferable. At present, in order to answer the needs, non-aqueous electrolyte battery, in particular lithium ion secondary battery making use of dope/undope (insertion/extraction) behavior of lithium has become incorporated in most instruments, by virtue of its excellent energy density.

The lithium ion secondary battery generally adopts, for example, a positive electrode having a positive electrode active material layer using a lithium complex oxide such as lithium cobalt oxide formed on a positive electrode current collector and a negative electrode having a negative electrode active material layer using a carbon material formed on a negative electrode current collector, and is used under the operation voltage ranging from 2.5 V to 4.2 V. The terminal voltage of a single battery cell successfully elevated to as high as 4.2 V is largely ascribable to excellent electro-chemical stability of the non-aqueous electrolyte material, separator and so forth.

Aiming at obtaining further excellent energy density of this sort of lithium ion secondary battery, Japanese Patent Publication No. 2701347 defines the total thickness respectively for the positive electrode active material layer and the negative electrode active material layer, and defines ratio of the total thickness of the positive electrode active material layer to the total thickness of the negative electrode active material layer.

In the Japanese Patent Publication No. 2701347, a non-aqueous electrolyte secondary battery is manufactured to adjust the total thickness “A” of the positive electrode active material layer and the total thickness “B” of the negative electrode active material layer respectively to 80 μm to 250 μm. By adjusting the ratio of the total thickness “A” of the positive electrode active material layer to the total thickness “B” of the negative electrode active material layer to 0.4 to 2.2, excellent energy density is obtained.

However, in the lithium ion secondary battery operable at as high as 4.2 V, the entire portion of the theoretical capacity of the positive electrode active material used therefor, such as lithium cobalt oxide, cannot be fully utilized, instead using only as much as 60% or around of the capacity. Aiming at further improving battery characteristics of the secondary battery, a battery further elevated in the charging termination voltage to as high as 4.25 V or above is described typically in WO03/019713 pamphlet.

The above-described battery is known to increase the amount of lithium doped/undoped, or, inserted/extracted to or from the gap between the layers of carbon material by adjusting the charging voltage to as high as 4.25 V or above, and to succeed in raising the capacity and the energy density of the lithium ion secondary battery.

Elevation of the charging voltage of the battery results in increase in the amount of lithium ions drawn out from the positive electrode, and consequently raises a need of increasing the thickness of the negative electrode in order to accept the lithium ions, but also raises a problem in that acceptability of lithium correspondingly degrades. If the lithium acceptability degrades, a part of lithium ions may deposit on the surface of the negative electrode, rather than being doped into the gap between the layers of the carbon material, and a side reaction may proceed between the deposited lithium and the electrolyte, so as to degrade the cycle characteristics.

It may be possible to prevent the cycle characteristics from being degraded, by thinning the positive electrode. Thinning of the positive electrode, however, reduces the amount of positive electrode active material, and consequently results in considerable decrease in the battery capacity.

Aiming at thinning, lithium ion secondary batteries using gel-form electrolyte are widely adopted at present, but the gel-form electrolyte suffers from a problem in degradation of the cycle characteristics, due to its lower ion conductivity as compared with electrolytic solution which is a liquid-form electrolyte. Further improvement in the cycle characteristics has, therefore, been desired for the gel-form electrolyte battery.

The invention disclosed in Japanese Patent Publication No. 2701347 describes improvement in the energy density, by adjusting the total thickness of the positive electrode active material layer, the total thickness of the negative electrode active material layer, and the ratio of the total thickness of the positive electrode active material layer to the total thickness of the negative electrode active material layer. However, the patent document gives no description on improvement in the cycle characteristics of the secondary battery charged at a voltage as high as 4.25 V or above.

### SUMMARY

The present embodiments provide a secondary battery having a high charging voltage, and having excellent cycle characteristics without causing degradation in the battery capacity.

According to an embodiment, there is provided a secondary battery including a positive electrode having a positive electrode active material layer provided on a positive electrode current collector, a negative electrode having a negative electrode active material layer provided on a negative electrode current collector, and an electrolyte, the positive electrode and the negative electrode being stacked and rolled up while placing a separator in between. In the secondary battery, a sum (A+B) of total thickness “A” of the thickness of the positive electrode current collector and the thickness of the positive electrode active material layer provided to the positive electrode current collector and total thickness “B” of the thickness of the negative electrode current collector and the thickness of the negative electrode active material layer provided to the negative electrode current collector falls in the range from 161 μm to 220 μm, both ends inclusive. Also, a ratio (A/B) of total thickness “A” of the positive electrode to total thickness “B” of the negative electrode falls in the range from 0.65 to 1.9, both ends inclusive.

The above-described secondary battery preferably has the open circuit voltage under completely charged state per a single pair of the positive electrode and the negative electrode fallen in the range from 4.25 V to 4.50 V, both ends inclusive.

The above-described electrolyte may be a gel-form electrolyte, and the gel-form electrolyte may be composed of a copolymer of hexafluoropropylene with polyvinylidene fluoride or with vinylidene fluoride, and an electrolytic solution containing a non-aqueous solvent and an electrolyte salt immersed therein.

The above-described, non-aqueous solvent is preferably a carbonate ester compound containing ethylene carbonate and propylene carbonate, and a ratio by weight of the ethylene carbonate to the propylene carbonate preferably falls in the range from 0.25 to 1.50, both ends inclusive.

The present embodiments successfully prevent either of, or both of the positive electrode active material and the negative electrode active material from decreasing, and thereby prevent the battery capacity from coming short, by appropriately adjusting the sum (A+B) of total thickness “A” of the positive electrode and total thickness “B” of the negative electrode, and the ratio (A/B) of total thickness “A” of the positive electrode to total thickness “B” of the negative electrode. The present embodiments ensure a large thickness of the negative electrode, and can thereby prevent the lithium ions from depositing on the surface of the negative electrode, without being fully doped into the gap between the layers of the carbon material due to lowered acceptability to the lithium ions. The present embodiments also ensure larger thickness of the positive electrode than that of the negative electrode, and can thereby prevent the lithium ions from depositing on the surface of the negative electrode, without being fully doped into the gap between the layers of the carbon material.

Additional features and advantages are described herein, and will be apparent from, the following Detailed Description and the figures.

### BRIEF DESCRIPTION OF THE FIGURES

FIG. 1 is a schematic drawing showing a configuration of a non-aqueous electrolyte secondary battery according to one embodiment; and

FIG. 2 is a schematic drawing showing a configuration of a cell element of a non-aqueous electrolyte secondary battery according to one embodiment.

### DETAILED DESCRIPTION

An embodiment is described below, referring to the attached drawings.

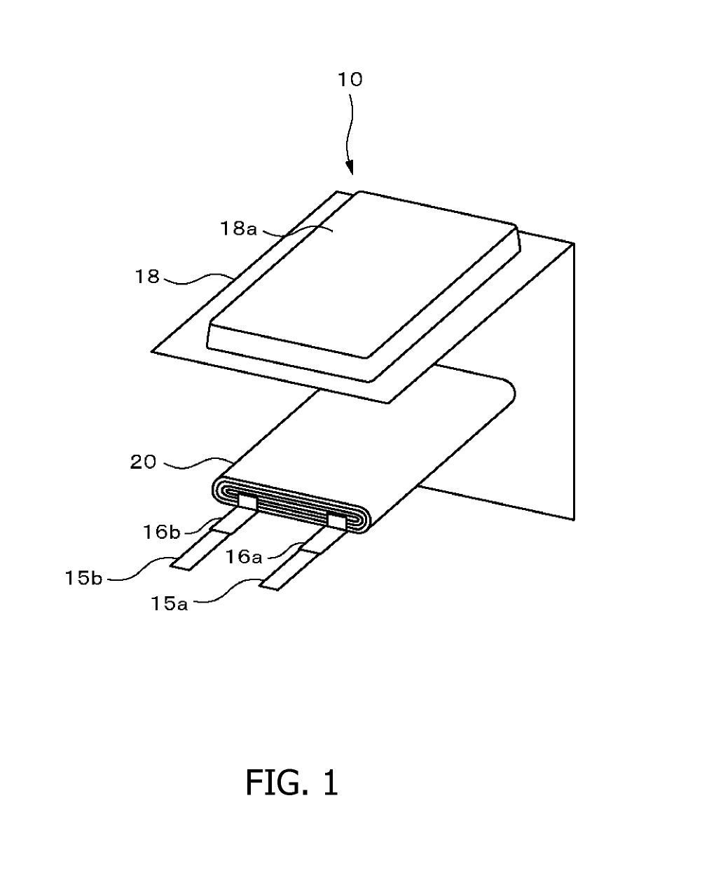

FIG. 1 is a schematic drawing showing an exemplary configuration of a non-aqueous electrolyte secondary battery 10 according to an embodiment. The non-aqueous electrolyte secondary battery 10 is fabricated by packaging a cell element (hereinafter, referred to as cell) 20 as being housed in a cell housing 18a, which is a recess formed in a laminating film 18, and by sealing the outer circumference of the cell 20. Paragraphs below will explain a configuration of the cell 20.

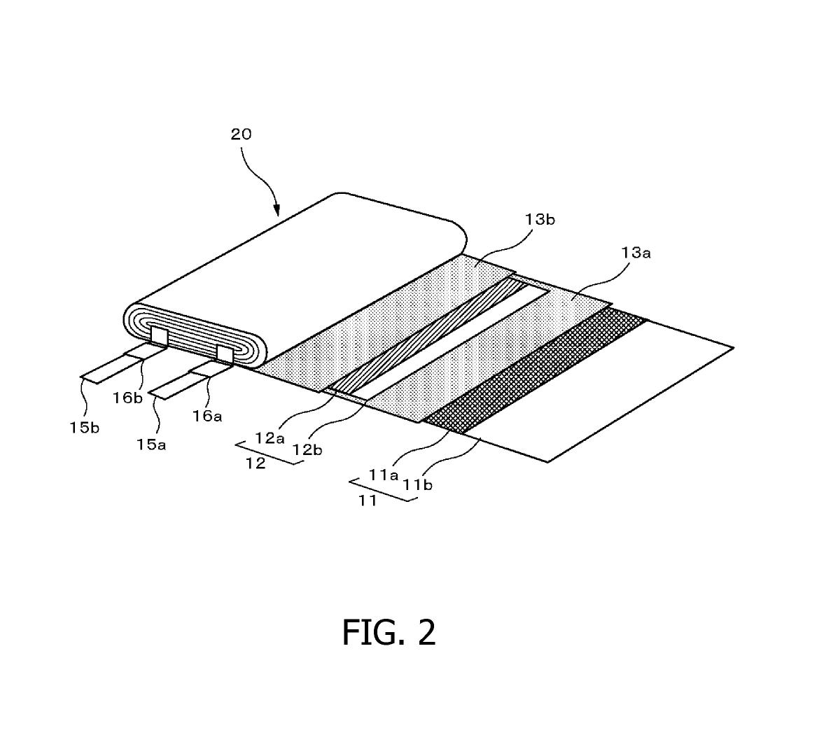

FIG. 2 shows an appearance of the cell 20. The cell 20 is a rolled cell having a band-like positive electrode 11, a separator 13a, a band-like negative electrode 12 disposed as being opposed to the positive electrode 11, and a separator 13b, stacked in this order and rolled up in the longitudinal direction thereof. In the cell 20, on both surfaces of the positive electrode 11 and the negative electrode 12, a gel-form electrolyte not shown is coated. From the cell 20, a positive electrode terminal 15a connected to the positive electrode 11, and a negative electrode terminal 15b connected to the negative electrode 12 are drawn out (simply referred to as an electrode terminal 15, hereinafter, if there is no need of specify either of the terminals). To the positive electrode terminal 15a and to the negative electrode terminal 15b, sealants 16a and 16b typically composed of polyethylene (PE) are disposed for the purpose of improving adhesiveness with a laminating film 18 later used for packaging.

[Electrodes]

The positive electrode 11 is configured so that a positive electrode active material layer 11a containing a positive electrode active material is formed on both surfaces of a positive electrode current collector 11b. As the positive electrode current collector 11b, a metal foil such as aluminum (Al) foil, nickel (Ni) foil, stainless steel (SUS) foil or the like is applicable.

The positive electrode active material layer 11a is typically configured as containing a positive electrode active material, an electro-conductive material, and a binder. It is good enough herein for the positive electrode active material, the electro-conductive material and the binder to uniformly disperse, without need of specifying the ratio of mixing.

As the positive electrode active material, a single, or two or more species of positive electrode active materials, capable of occluding and releasing lithium, can be used, for example. Appropriate examples of the positive electrode active material, capable of occluding and releasing lithium, include lithium-containing transition metal compounds such as lithium oxide, lithium phosphate and lithium sulfate. In view of raising the energy density, lithium-containing transition metal oxides containing lithium, transition metal element and oxygen (O) are preferable, and among others, those containing as the transition metal element at least one element selected from the group consisting of cobalt (Co), Ni, manganese (Mn) and iron (Fe) are more preferable. This sort of lithium-containing transition metal compounds can be exemplified by lithium-containing transition metal oxide having a layered rock salt structure expressed by formula 1 below, and lithium complex phosphate salt having an olivine structure expressed by the formula 2 below, and more specifically by LiCoO₂, LiNiO₂, LiNi_{c}Co_{1-c}O₂(0<c<1), LiMn₂O₄, LiFePO₄ and so forth. The transition metal element may be used in combination of a plurality of species thereof, and examples of which include LiNi_{0.50}Co_{0.50}O₂, LiNi_{0.50}Co_{0.30}Mn_{0.20}O₂ and LiFe_{0.50}Mn_{0.50}PO₄.

LiₚNi_{(1-q-r)}Mn_{q}M1ᵣO_{(2-y)}X_{z} [Formula 1]

where, “M1” expresses at least one element selected from Group-II to Group-XV elements excluding Ni and Mn, and “X” expresses at least one element selected from Group-XVI elements and Group-XVII elements excluding oxygen (O). “p”, “q”, “y” and “z” are values satisfying 0≦p≦1.5, 0≦q≦1.0, 0≦r≦1.0, −0.10≦y≦0.20, 0≦z≦0.2, respectively.

LiₐM2_{b}PO₄ [Formula 2]

where, “M2” expresses at least one element selected from Group-II to Group-XV elements, and “a” and “b” are values satisfying 0≦a≦2.0 and 0.5≦b≦2.0, respectively.

Examples applicable as the electro-conductive material include carbon materials such as carbon black and graphite. As the binder, polyvinylidene fluoride, polytetrafloroethylene or the like can be used.

The negative electrode 12 is configured as having a negative electrode active material layer 11a, containing a negative electrode active material, formed on both surfaces of a negative electrode current collector 12b. The negative electrode current collector 12b is typically composed of a metal foil such as copper (Cu) foil, nickel foil or stainless steel foil.

The negative electrode active material layer 11a is typically configured as containing a negative electrode active material, and if necessary, an electro-conductive material and a binder. As for the negative electrode active material, the electro-conductive material, the binder and a solvent used herein, there are no special limitations on the ratio of mixing, similar to the case of positive electrode active material.

As the negative electrode active material, a carbon material allowing lithium to dope (insert) thereinto and to undope (extract) therefrom, or a composite material of a metallic material and a carbonaceous material can be used. More specifically, examples of the carbon material allowing lithium to dope thereinto and to undope therefrom include graphite, non-graphatizable carbon, and graphatizable carbon. More specifically, carbon materials such as pyrolytic carbons, cokes (pitch coke, needle coke, petroleum coke), graphites, vitreous (glassy) carbons, sintered organic polymer compound (obtained by sintering, and thereby carbonizing, phenol resin, furan resin or the like at appropriate temperatures), carbon fiber, and activated carbon can be used. It is also allowable to use polymers such as polyacetylene, polypyrrole or the like, and oxides such as SnO₂, as the material allowing lithium to dope thereinto and undope therefrom.

As the binder, polyvinylidene fluoride, styrene-butadiene rubber and so forth are adoptable. As the solvent, N-methylpyrrolidone, methyl ethyl ketone and the like can be used.

Assuming now that the total thickness of the positive electrode as “A”, and the total thickness of the negative electrode as “B”, the positive electrode 11 and the negative electrode 12 are configured so as to adjust a sum (A+B) of total thickness “A” of the positive electrode and total thickness “B” of the negative electrode to 161 μm to 220 μm, both ends inclusive, and so as to adjust a ratio (A/B) of total thickness “A” of the positive electrode to the total thickness “B” of the negative electrode to 0.65 to 1.9, both ends inclusive.

This is because the sum (A+B) of total thickness “A” of the positive electrode and total thickness “B” of the negative electrode smaller than 161 μm results in lowering in the battery capacity due to a small thickness of the electrodes, and the sum (A+B) exceeding 220 μm results in degradation of the cycle characteristics due to too large thickness of the electrodes. In a case where the ratio (A/B) of total thickness “A” of the positive electrode to the total thickness “B” of the negative electrode is smaller than 0.65, a smaller (A+B) value corresponds to larger decrease in the battery capacity due to decrease in the amount of positive electrode active material, whereas a larger (A+B) value corresponds to larger battery capacity but more degraded cycle characteristics. On the other hand, when the ratio (A/B) exceeds 1.90, lithium deposits on the surface of the negative electrode due to excessive amount of the positive electrode active material, and thereby the cycle characteristics degrade.

Total thickness “A” of the positive electrode is expressed as:

total thickness “A”=(A₁+A₂+A₃)

assuming A₁ and A₂ as the thickness of the positive electrode active material layer 11a formed respectively on both surfaces of the positive electrode current collector 11b, and A₃ as the thickness of the positive electrode current collector 11b, and similarly total thickness “B” of the negative electrode is expressed as:

total thickness “B”=(B₁+B₂+B₃)

assuming B₁ and B₂ as the thickness of the negative electrode active material layer 12a formed respectively on both surfaces of the negative electrode current collector 12b, and B₃ as the thickness of the negative electrode current collector 12b.

The thickness was measured using a micrometer, wherein the micrometer may be, for example, a static-pressure thickness gauge (from Tech-Jam, PG-1 KN3311755).

[Gel-Form Electrolyte]

The gel-form electrolyte is configured by gelling the electrolytic solution using a matrix polymer. As the electrolytic solution, those generally used for lithium ion secondary battery are adoptable. As this sort of electrolytic solution, a non-aqueous electrolytic solution obtained by dissolving an electrolyte salt into a non-aqueous solvent can be used.

Specific examples of the non-aqueous solvent include ethylene carbonate, propylene carbonate, γ-butyrolactone, dimethyl carbonate, diethyl carbonate, ethyl methyl carbonate, dipropyl carbonate, ethyl propyl carbonate, and any solvents obtained by substituting hydrogens of these carbonate esters with halogen. Only one of these solvents may independently be used, or a plurality of them may be used in a mixed form according to a predetermined composition.

Among others, a non-aqueous solvent having ethylene carbonate (EC) and propylene carbonate (PC) mixed therein is preferable. In a case where the non-aqueous solvent having EC and PC mixed therein is used, the electrolytic solution is preferably configured so as to adjust the ratio of EC to PC to EC:PC=20:80 to EC:PC=60:40, by weight, in other words, so as to adjust the ratio of EC with respect to PC (EC/PC) to 0.25 to 1.50, both ends inclusive. This is because (EC/PC) smaller than 0.25 (PC excessive) causes reductive decomposition of PC, and (EC/PC) exceeding 1.50 (EC excessive) typically causes decomposition of the electrolytic solution during the cycle, to thereby degrade the cycle characteristics.

The electrolyte salt may be composed of any materials used for electrolytic solution of general batteries. More specifically, LiCl, LiBr, LiI, LiClO₃, LiClO₄, LiBF₄, LiPF₆, LiNO₃, LiN(CF₃SO₂)₂, LiN(C₂F₅SO₂)₂, LiAsF₆, LiCF₃SO₃, LiC(SO₂CF₃)₃, LiAlCl₄, LiSiF₆ and so forth can be exemplified. Among them, LiPF₆ and LiBF₄ are preferable in view of stability against oxidation. Only a single species of these lithium salts may independently be used, or a plurality of species may be used in a mixed form. Concentration of the lithium salt is not specifically limited so far as the salt can dissolve into the above-described solvents, in which lithium ion concentration preferably falls in the range from 0.4 mol/kg to 2.0 mol/kg, both ends inclusive, in the non-aqueous solvent.

The matrix polymer may be anything provided that it is compatible with the non-aqueous electrolytic solution composed of the non-aqueous solvent and the electrolyte salt dissolved therein, and it can be gelled. Examples of this matrix polymer include fluorocarbon polymer compound such as copolymers with polyvinylidene fluoride or with vinylidene fluoride, ether-base polymer compounds such as polyethylene oxide or crosslinked products containing polyethylene oxide, and polymers having polypropylene oxide, polyacrylonitrile, polymethacrylonitrile, as the repetitive unit. Only a single species of such polymer may independently be used, or two or more species may be used in a mixed manner.

Among others, fluorocarbon-base polymer compound is particularly preferable in view of redox stability. For example, a polymer having 7.5% of hexafluoropropylene incorporated into polyvinylidene fluoride or vinylidene fluoride can be used. This sort of polymer has a number average molecular weight of 5.0×10⁵ to 7.0×10⁵ (500,000 to 700,000), or a mass average molecular weight of 2.1×10⁵ to 3.1×10⁵ (210,000 to 310,000), and has an intrinsic viscosity adjusted to the range from 1.7 to 2.1.

[Separator]

The separator 13 is configured using, for example, a porous film composed of a polyolefinic material such as polyethylene (PE) or polypropylene (PP), or of a porous film composed of an inorganic material such as ceramic-made, non-woven fabric.

The thickness of the separator 13 herein is preferably 1 μm to 9 μm, both ends inclusive. The separator 13 having a thickness of smaller than 1 μm may result in internal short-circuiting of the battery due to lowered mechanical strength of the film. On the other hand, the thickness exceeding 10 μm results in degradation in the capacity as the number of cycles of the battery increases. It also results in lowering in the amount of packing of the active material to thereby lower the battery capacity, and also results in lowering in the ion conductivity to thereby degrade the current characteristics.

The non-aqueous electrolyte battery configured as described in the above can be fabricated by the methods described below, for example.

[Fabrication of Positive Electrode]

The above-described positive electrode active material, the binder, and the electro-conductive material are uniformly mixed to thereby prepare a positive electrode mixture, and the positive electrode mixture is then dispersed into a solvent to thereby prepare positive electrode mixture slurry. Next, this positive electrode mixture slurry is coated, for example, adopting the doctor blade method. Next, the coating is dried at high temperatures so as to vaporize the solvent, and thereby the positive electrode active material layer 11a is formed. The solvent used herein is N-methyl pyrrolidone, for example.

The positive electrode 11 has a positive electrode terminal 15a connected to one end of the positive electrode current collector 11b by spot welding or by ultrasonic welding. The positive electrode terminal 15a is preferably in a form of metal foil or mesh, wherein even materials other than metals are also allowable so far as they are stable from electro-chemical and chemical viewpoints, and can ensure electrical conduction. Materials of the positive electrode terminal 15a include aluminum.

[Fabrication of Negative Electrode]

The above-described negative electrode active material, the electro-conductive material, and the binder are uniformly mixed to thereby prepare a negative electrode mixture, and the mixture is dispersed into a solvent to thereby obtain negative electrode mixture slurry. Next, the negative electrode mixture slurry is uniformly coated on the negative electrode current collector by a method similar to that adopted for the positive electrode, the coating is dried at high temperatures so as to vaporize the solvent, and thereby the negative electrode active material layer 12a is formed.

Similar to the positive electrode 11, the negative electrode 12 also has the negative electrode terminal 15b connected to one end of the negative electrode current collector by spot welding or ultrasonic welding. The negative electrode terminal 15b may be composed of any materials other than metals so far as they are stable from electro-chemical and chemical viewpoints, and can ensure electrical conduction. Materials composing the negative electrode terminal 15b include copper and nickel.

The positive electrode terminal 15a and the negative electrode terminal 15b are preferably drawn out into the same direction, but may be drawn out into any directions, so far as short-circuiting is avoidable, and no problems are raised in the battery performance. Positions of connection and methods of connection of the positive electrode terminal 15a and the negative electrode terminal 15b are not limited to the above-described example, so far as electrical connection can be ensured.

[Fabrication of Battery]

The electrolytic solution prepared as described in the above is then uniformly coated on the positive electrode 11 and the negative electrode 12, allowed to immerse into the positive electrode active material layer and into the negative electrode active material layer, stored under normal temperature or subjected to drying process, to thereby form the gel-form electrolyte layer. The positive electrode 11 and the negative electrode 12 having the gel-form electrolyte layer formed thereon are then stacked in the order of the positive electrode 11, the separator 13a, the negative electrode 12 and the separator 13b, and rolled up, to thereby form the cell 20.

The cell 20 is then packaged using the laminating film 18 as shown in FIG. 1, and the outer circumference of the cell 20 is then sealed to thereby fabricate the non-aqueous electrolyte secondary battery 10. The non-aqueous electrolyte secondary battery 10 fabricated as described in the above can realize excellent cycle characteristics, without being lower the battery capacity, even under high charging voltage.

### Examples

The present embodiments are specifically explained below, referring to specific examples.

<Sample 1 to Sample 48>

The non-aqueous electrolyte secondary batteries were fabricated while varying the sum (A+B) of the total thickness of the positive electrode and the negative electrode, and the ratio (A/B) of total thickness “A” of the positive electrode to total thickness “B” of the negative electrode as listed in Table 1, and the initial capacity and the ratio of capacity retention after 200 cycles were obtained.

TABLE 1

| | Sum of total thickness | Total thickness of | Total thickness of | Ratio of total thickness | Initial | Ratio of capacity |
|---|---|---|---|---|---|---|
| | of positive and negative | positive electrode | negative electrode | of positive and negative | capacity | retention after 200 |
| | electrodes [μm] | A [μm] | B [μm] | electrodes A/B | [mAh] | cycles [%] |
| Sample 1 | 146 | 54 | 92 | 0.58 | 608 | 92 |
| Sample 2 | 146 | 58 | 88 | 0.65 | 632 | 93 |
| Sample 3 | 146 | 66 | 80 | 0.82 | 658 | 95 |
| Sample 4 | 146 | 69 | 77 | 0.89 | 684 | 96 |
| Sample 5 | 146 | 73 | 73 | 1.01 | 711 | 94 |
| Sample 6 | 146 | 88 | 58 | 1.50 | 733 | 90 |
| Sample 7 | 146 | 96 | 50 | 1.90 | 755 | 84 |
| Sample 8 | 146 | 97 | 49 | 2.00 | 770 | 79 |
| Sample 9 | 161 | 59 | 102 | 0.58 | 799 | 86 |
| Sample 10 | 161 | 63 | 98 | 0.65 | 831 | 89 |
| Sample 11 | 161 | 73 | 88 | 0.82 | 864 | 91 |
| Sample 12 | 161 | 76 | 85 | 0.89 | 899 | 94 |
| Sample 13 | 161 | 81 | 80 | 1.01 | 935 | 92 |
| Sample 14 | 161 | 97 | 64 | 1.50 | 963 | 89 |
| Sample 15 | 161 | 105 | 56 | 1.90 | 992 | 86 |
| Sample 16 | 161 | 107 | 54 | 2.00 | 1011 | 78 |
| Sample 17 | 172 | 63 | 109 | 0.58 | 826 | 81 |
| Sample 18 | 172 | 68 | 104 | 0.65 | 859 | 86 |
| Sample 19 | 172 | 77 | 95 | 0.82 | 893 | 89 |
| Sample 20 | 172 | 81 | 91 | 0.89 | 929 | 92 |
| Sample 21 | 172 | 86 | 86 | 1.01 | 966 | 90 |
| Sample 22 | 172 | 103 | 69 | 1.50 | 995 | 88 |
| Sample 23 | 172 | 113 | 59 | 1.90 | 1025 | 85 |
| Sample 24 | 172 | 115 | 57 | 2.00 | 1046 | 76 |
| Sample 25 | 204 | 75 | 129 | 0.58 | 880 | 75 |
| Sample 26 | 204 | 80 | 124 | 0.65 | 915 | 82 |
| Sample 27 | 204 | 92 | 112 | 0.82 | 952 | 85 |
| Sample 28 | 204 | 96 | 108 | 0.89 | 990 | 89 |
| Sample 29 | 204 | 103 | 101 | 1.01 | 1029 | 87 |
| Sample 30 | 204 | 122 | 82 | 1.50 | 1060 | 84 |
| Sample 31 | 204 | 134 | 70 | 1.90 | 1092 | 82 |
| Sample 32 | 204 | 136 | 68 | 2.00 | 1114 | 70 |
| Sample 33 | 220 | 81 | 139 | 0.58 | 920 | 71 |
| Sample 34 | 220 | 87 | 133 | 0.65 | 957 | 80 |
| Sample 35 | 220 | 99 | 121 | 0.82 | 995 | 82 |
| Sample 36 | 220 | 104 | 116 | 0.89 | 1035 | 86 |
| Sample 37 | 220 | 111 | 109 | 1.01 | 1076 | 84 |
| Sample 38 | 220 | 132 | 88 | 1.50 | 1109 | 82 |
| Sample 39 | 220 | 144 | 76 | 1.90 | 1142 | 80 |
| Sample 40 | 220 | 147 | 73 | 2.00 | 1165 | 62 |
| Sample 41 | 228 | 84 | 144 | 0.58 | 937 | 62 |
| Sample 42 | 228 | 90 | 138 | 0.65 | 974 | 71 |
| Sample 43 | 228 | 103 | 125 | 0.82 | 1013 | 76 |
| Sample 44 | 228 | 107 | 121 | 0.89 | 1054 | 78 |
| Sample 45 | 228 | 115 | 113 | 1.01 | 1096 | 75 |
| Sample 46 | 228 | 137 | 91 | 1.50 | 1129 | 70 |
| Sample 47 | 228 | 149 | 79 | 1.90 | 1163 | 65 |
| Sample 48 | 228 | 152 | 76 | 2.00 | 1186 | 58 |

Methods of fabricating the non-aqueous electrolyte secondary batteries are explained below.

[Fabrication of Positive Electrode]

The positive electrode mixture was prepared by uniformly mixing 92 wt % of lithium cobalt oxide (LiCoO₂) as a positive electrode active material, 5 wt % of pulverized graphite as the electro-conductive material, and 3 wt % of pulverized polyvinylidene fluoride as the binder, and the mixture was dispersed into N-methyl pyrrolidone to thereby prepare positive electrode mixture slurry. The positive electrode mixture slurry was then uniformly coated on both surfaces of an Al foil, which serves as the positive electrode current collector, and dried at 100° C. for 24 hours under reduced pressure, and thereby the positive electrode active material layer was formed.

The product was rolled under pressure using a roll press machine to thereby produce a positive electrode sheet, and the positive electrode sheet was then cut into a size of 50 mm long and 350 mm wide, to thereby fabricate the positive electrode. Leads composed of an Al ribbon of 3 mm wide were welded to portions having no active material coated thereon, to thereby fabricate the positive electrodes having the individual thicknesses listed in Table 1.

[Fabrication of Negative Electrode]

A negative electrode mixture was prepared by uniformly mixing 91 wt % of artificial graphite as the negative electrode active material, and 9 wt % of pulverized polyvinylidene fluoride as the binder, and the mixture was dispersed into N-methyl pyrrolidone, to thereby prepare the negative electrode mixture slurry. Next, the negative electrode mixture slurry was uniformly coated on both surfaces of a copper foil, which serves as the negative electrode current collector, and dried at 120° C. for 24 hours under reduced pressure, to thereby form the negative electrode active material layer.

The product was rolled under pressure using a roll press machine to thereby produce a negative electrode sheet, and the negative electrode sheet was then cut into a size of 52 mm long and 370 mm wide, to thereby fabricate the negative electrode. Leads composed of an Ni ribbon of 3 mm wide were welded to portions having no active material coated thereon, to thereby fabricate the negative electrodes having the individual thicknesses listed in Table 1.

[Fabrication of Gel-Form Electrolyte]

Polyvinylidene fluoride copolymerized with 6.9% of hexafluoropropylene, a non-aqueous electrolytic solution, and dimethyl carbonate (DMC) as a diluting solvent are mixed, stirred, and allowed to dissolve, to thereby obtain a sol-form electrolytic solution. The non-aqueous electrolytic solution was prepared by mixing ethylene carbonate and propylene carbonate in a ratio by weight of 6:4, and by dissolving therein 0.7 mol/kg of LiPF₆ as the electrolyte salt. The ratio of mixing was such as polyvinylidene fluoride:electrolytic solution:DMC=1:6:12. The sol-form electrolytic solution obtained as described in the above was then uniformly coated on both surfaces of the positive electrode and the negative electrode. The coating was then dried at 50° C. for 3 minutes so as to remove the solvent, and thereby the gel-form electrolyte layers were formed on both surfaces of the positive electrode and the negative electrode.

Next, the band-like positive electrode having the gel-form electrolyte layers formed on both surfaces thereof, and the band-like negative electrode having the gel-form electrolyte layers formed on both surfaces thereof were stacked while placing a separator composed of a polyethylene stretched film in between, the stack was rolled up in the longitudinal direction thereof to thereby fabricate the cell, and packaged into the laminating film, to thereby obtain the non-aqueous electrolyte secondary battery.

Initial capacity and ratio of capacity retained after 200 cycles of the non-aqueous electrolyte secondary battery fabricated as described in the above were measured, respectively as explained below.

(1-1) Initial Capacity

Each of the above-described, non-aqueous electrolyte secondary batteries were charged by constant-current charging under an environment at 23° C. and a charging current of 790 mA, and then by constant-voltage charging changed over when a charging voltage of 4.35 V was achieved, and the charging was continued until the total charging time reaches 4 hours. Each battery was then allowed to discharge at 0.2 C (158 mA), and the discharge was terminated when the voltage dropped to 3.0 V. The discharge capacity observed herein was defined as the initial capacity.

(1-2) Ratio of Capacity Retention

Each of the above-described, non-aqueous electrolyte secondary batteries were charged by constant-current charging under an environment at 23° C. and a charging current of 830 mA, and then by constant-voltage charging changed over when a charging voltage of 4.35 V was achieved, and the charging was continued until the total charging time reaches 4 hours. Each battery was then allowed to discharge at 1 C (830 mA), which was terminated when the voltage dropped to 3.0 V, and the discharge capacity at this time was measured. Such charging/discharging cycle was repeated 200 times, and the discharge capacity after 200 cycles was measured. The ratio of capacity retention after 200 cycles was then calculated by {(discharge capacity after 200 cycles/discharge capacity after the first cycle)×100}.

The initial capacity and the ratio of capacity retention after 200 cycles of sample 1 to sample 48 are listed in Table 1. It is to be noted herein that an initial capacity of 830 mAh and a ratio of capacity retention after 200 cycles of 80% or more were considered as criteria for acceptance for practical use.

As is clear from the results, the initial capacity of the battery degraded, when summation (A+B) of total thickness “A” of the positive electrode and total thickness “B” of the negative electrode was 146 μm. The ratio of capacity retention after 200 cycles degraded, when the sum (A+B) of total thickness “A” of the positive electrode and total thickness “B” of the negative electrode was 228 μm. It is therefore preferable to adjust the sum (A+B) of total thickness “A” of the positive electrode and total thickness “B” of the negative electrode to 161 μm to 220 μm, both ends inclusive.

It was also found that, in a case where the ratio of total thickness “A” of the positive electrode to total thickness “B” of the negative electrode is smaller than 0.65, lowering in the initial capacity was observed for those having relatively small (A+B) values, as seen in sample 1, sample 9 and sample 17, whereas those having relatively large (A+B) values, such as sample 25, sample 33 and sample 41, satisfied the criteria for the initial capacity, but degraded in the ratio of capacity retention after 200 cycles. In a case where the ratio of total thickness “A” of the positive electrode to total thickness “B” of the negative electrode exceeding 1.90, all samples showed degraded ratio of capacity retention after 200 cycles. It is therefore preferable to adjust the ratio of total thickness “A” of the positive electrode to total thickness “B” of the negative electrode to 0.65 to 1.90, both ends inclusive.

Next, each of the non-aqueous electrolyte secondary batteries of sample 20 and sample 36 were subjected to charging/discharging under varied charging voltage of 4.20 V, 4.25 V, 4.35 V, 4.50 V and 4.55 V as shown in Table 2 below, and the initial capacity and ratio of capacity retention after 200 cycles were determined.

TABLE 2

| | Sum of total thickness | Total thickness of | Total thickness of | Ratio of total thickness | Charging | Initial | Ratio of capacity |
|---|---|---|---|---|---|---|---|
| | of positive and negative | positive electrode | negative electrode | of positive and negative | voltage | capacity | retention after |
| | electrodes [μm] | A [μm] | B [μm] | electrodes A/B | [V] | [mAh] | 200 cycles [%] |
| Sample 20 | 172 | 81 | 91 | 0.89 | 4.20 | 827 | 96 |
| Sample 20 | 172 | 81 | 91 | 0.89 | 4.25 | 883 | 95 |
| Sample 20 | 172 | 81 | 91 | 0.89 | 4.35 | 929 | 92 |
| Sample 20 | 172 | 81 | 91 | 0.89 | 4.50 | 985 | 84 |
| Sample 20 | 172 | 81 | 91 | 0.89 | 4.55 | 994 | 79 |
| Sample 36 | 220 | 104 | 116 | 0.89 | 4.20 | 921 | 91 |
| Sample 36 | 220 | 104 | 116 | 0.89 | 4.25 | 983 | 89 |
| Sample 36 | 220 | 104 | 116 | 0.89 | 4.35 | 1035 | 86 |
| Sample 36 | 220 | 104 | 116 | 0.89 | 4.50 | 1097 | 80 |
| Sample 36 | 220 | 104 | 116 | 0.89 | 4.55 | 1107 | 70 |

(2-1) Initial Capacity

The initial capacity was measured in a similar manner as in (1-1), except that the maximum achievable voltage during charging was varied among 4.20 V, 4.25 V, 4.35 V, 4.50 V and 4.55 V.

(2-2) Ratio of Capacity Retention

The ratio of capacity retention after 200 cycles was measured in a similar manner as in (1-2), except that the maximum achievable voltage during charging was varied among 4.20 V, 4.25 V, 4.35 V, 4.50 V and 4.55 V.

Table 2 shows the initial capacity and ratio of capacity retention after 200 cycles of sample 20 and sample 36. It is to be noted herein that an initial capacity of 830 mAh and a ratio of capacity retention after 200 cycles of 80% or more were considered as criteria for acceptance for practical use.

As is known from the results in the above, sample 20 having a film thickness of 172 μm resulted in decreased in the initial capacity under a charging voltage of 4.20 V. A charging voltage of 4.55 V resulted in increase in the initial capacity for both of sample 20 and sample 36, but resulted in decrease in the ratio of capacity retention after 200 cycles. The charging voltage is, therefore, preferably adjusted to 4.25 V to 4.50 V, both ends inclusive, so as to obtain large battery capacity and ratio of capacity retention, irrespective of the film thickness.

Next, the non-aqueous electrolyte secondary battery of sample 20 was charged and discharged, while varying the composition of EC and PC, which are non-aqueous solvents contained in the gel-form electrolyte, as listed in Table 3, and the initial capacity and the ratio of capacity retention after 200 cycles were determined.

TABLE 3

| | Sum of total thickness | Total thickness of | Total thickness of | Ratio of total thickness | | | Initial | Ratio of capacity |
|---|---|---|---|---|---|---|---|---|
| | of positive and negative | positive electrode | negative electrode | of positive and negative | | | capacity | retention after |
| | electrodes [μm] | A [μm] | B [μm] | electrodes A/B | EC:PC | EC/PC | [mAh] | 200 cycles [%] |
| Sample 20 | 172 | 81 | 91 | 0.89 | 0:100 | 0.00 | 883 | 61 |
| Sample 20 | 172 | 81 | 91 | 0.89 | 10:90 | 0.11 | 906 | 79 |
| Sample 20 | 172 | 81 | 91 | 0.89 | 20:80 | 0.25 | 920 | 85 |
| Sample 20 | 172 | 81 | 91 | 0.89 | 40:60 | 0.67 | 924 | 94 |
| Sample 20 | 172 | 81 | 91 | 0.89 | 50:50 | 1.00 | 929 | 92 |
| Sample 20 | 172 | 81 | 91 | 0.89 | 60:40 | 1.50 | 934 | 80 |
| Sample 20 | 172 | 81 | 91 | 0.89 | 70:30 | 2.33 | 938 | 54 |
| Sample 20 | 172 | 81 | 91 | 0.89 | 100:0 | — | — | — |

(3-1) Initial Capacity

The initial capacity was measured in a similar manner to as in (1-1), except that EC:PC was varied among 0:100, 10:90, 20:80, 40:60, 50:50, 60:40, 70:30 and 100:0, in the process of fabricating the gel-form electrolyte.

(3-2) Ratio of Capacity Retention

The ratio of capacity retention after 200 cycles was measured in a similar manner as in (1-2), except that EC:PC was varied among 0:100, 10:90, 20:80, 40:60, 50:50, 60:40, 70:30 and 100:0, in the process of fabricating the gel-form electrolyte.

The initial capacity and the ratio of capacity retention after 200 cycles of sample 20 were shown in Table 3. It is to be noted herein that an initial capacity of 830 mAh and a ratio of capacity retention after 200 cycles of 80% or more were considered as criteria for acceptance for practical use.

As is known from the results in the above, the ratio of capacity retention after 200 cycles degraded when EC:PC was 0:100, 10:90 and 70:30. This is ascribable to reductive decomposition of PC in the vicinity of the negative electrode for the case where PC is excessive (EC:PC of 0:100 or 10:90), and is ascribable to decomposition of the electrolytic solution during the cycle for the case where EC is excessive (EC:PC of 70:30). Moreover, the initial capacity and the ratio of capacity retention could not be measured under an EC:PC of 100:0. This is because EC is solid under a normal temperature, and EC alone cannot be used as the non-aqueous solvent. It is therefore preferable to adjust EC:PC to 20:80 to 60:40 on the weight basis, in other words, to adjust EC/PC to 0.25 to 1.50, both ends inclusive.

It is known from the results shown in the above that excellent cycle characteristics can be retained in the non-aqueous electrolyte secondary battery, having an open circuit voltage under completely charged state per a single pair of the positive electrode and the negative electrode of 4.25 V to 4.50 V, both ends inclusive, without degrading the battery capacity, by adjusting the sum (A+B) of total thickness “A” of the positive electrode and total thickness “B” of the negative electrode to 161 μm to 220 μm, both ends inclusive, and by adjusting the ratio (A/B) of total thickness “A” of the positive electrode to total thickness “B” of the negative electrode to 0.65 to 1.9, both ends inclusive, and further by adjusting the ratio by weight of EC and PC used as the non-aqueous solvent to 0.25 to 1.50, both ends inclusive.

Although the foregoing paragraphs have specifically explained one embodiment, the present disclosure is not limited by the above-described embodiment. Various modifications and combinations may be made based on the spirit and scope of the present disclosure.

For example, numerals exemplified in one embodiment described in the above are merely for exemplary purposes, and other different values may be used, if necessary.

Although the above-described one embodiment explained the case where the present disclosure was applied to the non-aqueous electrolyte secondary battery having a rolled-up structure applied with the present disclosure, the present disclosure may be applicable to other types of secondary battery, such as cylindrical, oval, or polygonal secondary batteries having the rolled-up structure, or secondary batteries having folded or stacked positive electrode and negative electrode. Furthermore, the present disclosure is still also applicable to so-called coin type, button type and card type secondary batteries.

Although the above-described one embodiment explained the case where the present disclosure was applied to the secondary battery having the gel-form electrolyte containing the electrolytic solution as being retained by the polymer compound, the present disclosure is applicable also to any other secondary batteries having other electrolytes. Such other electrolytes can be exemplified by polymer solid electrolyte making use of ion-conductive polymer, and inorganic solid electrolyte making use of ion-conductive inorganic material, and these solid electrolytes may independently be used, or may be used in combination with other electrolytes. Examples of the polymer compounds applicable to the polymer solid electrolyte include polyether, polyester, polyphosphazene and polysiloxane. Examples of the inorganic solid electrolyte include ion-conductive ceramic, ion-conductive crystal, and ion-conductive glass.

According to the present disclosure, a secondary battery having a high charging voltage, and having excellent cycle characteristics without causing degradation in the battery capacity, can be obtained.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A secondary battery comprising:
a positive electrode having a positive electrode active material layer provided on a positive electrode current collector;
a negative electrode having a negative electrode active material layer provided on a negative electrode current collector; and
an electrolyte, in which the positive electrode and the negative electrode are stacked and rolled up while placing a separator in between, wherein:
wherein a sum (A+B) of a total thickness “A” of a thickness of the positive electrode current collector and a thickness of the positive electrode active material layer, and a total thickness “B” of a thickness of the negative electrode current collector and a thickness of the negative electrode active material layer ranges from 161 μm to 220 μm, both ends inclusive, and
wherein a ratio (A/B) of the total thickness “A” of the positive electrode to the total thickness “B” of the negative electrode ranges from 0.65 to 1.9, both ends inclusive.

2. The secondary battery as claimed in claim 1, wherein an open circuit voltage under completely charged state per a single pair of the positive electrode and the negative electrode ranges from 4.25 V to 4.50 V, both ends inclusive.

3. The secondary battery as claimed in claim 1, wherein the electrolyte is a gel-form electrolyte, the gel-form electrolyte includes a copolymer of hexafluoropropylene with polyvinylidene fluoride or with vinylidene fluoride, and an electrolytic solution containing a non-aqueous solvent and an electrolyte salt immersed therein.

4. The secondary battery as claimed in claim 3, wherein the non-aqueous solvent is a carbonate ester compound containing ethylene carbonate and propylene carbonate, and wherein a ratio by weight of the ethylene carbonate to the propylene carbonate ranges from 0.25 to 1.50, both ends inclusive.

5. The secondary battery as claimed in claim 3, wherein the electrolyte salt is a lithium salt comprising LiPF₆.

6. The secondary battery as claimed in claim 1, wherein the separator comprises polyethylene (PE) or polypropylene (PP).

7. The secondary battery as claimed in claim 3, wherein the gel-form electrolyte is a layer formed by uniformly coating the electrolytic solution onto the positive electrode and the negative electrode, so as to immerse the electrolytic solution thereinto.
